(19) United States
(12) Patent Application Publication
(10) Pub. No.: US 2010/0331222 A1
(43) Pub. Date: Dec. 30, 2010

(54) PROCESS FOR PRODUCING CELLULOSE BEADS FROM SOLUTIONS OF CELLULOSE IN IONIC LIQUID

(75) Inventors: Markus Braun, Heidelberg (DE); Norbert Guentherberg, Speyer (DE); Michael Lutz, Speyer (DE); Andrea Magin, Ludwigshafen (DE); Michael Siemer, Mannheim (DE); Vijay Narayanan Swaminathan, Ludwigshafen (DE); Bernhard Linner, Bobenheim-Roxheim (DE); Franky Ruslim, Karlsruhe (DE); Gimmy Alex Fernandez Ramierz, Ludwigshafen (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/823,543

(22) Filed: Jun. 25, 2010

(30) Foreign Application Priority Data
Jun. 26, 2009 (EP) 09163883.3

(51) Int. Cl. C09K 8/58; C08B 1/00

(52) U.S. Cl. 507/206; 536/56; 507/214

(57) ABSTRACT

Process for producing cellulose beads or lignocellulose beads, wherein cellulose or lignocellulose is dissolved in a solvent which comprises more than 50% by weight of the symmetrical imidazolium compound of the formula I below

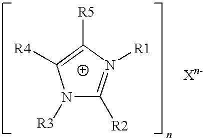

where
R1 and R3 are each an identical organic radical having from 2 to 20 carbon atoms, R2, R4 and R5 are each an H atom, X is an anion and n is 1, 2 or 3,
and
cellulose beads or lignocellulose beads are produced from the solution obtained, and also the use of the beads obtained for petroleum or natural gas recovery.

The invention relates to a process for producing cellulose beads or lignocellulose beads, wherein cellulose or lignocellulose is dissolved in a solvent which comprises more than 50% by weight of the symmetrical imidazolium compound of the formula I below

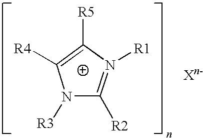

where
R1 and R3 are each an identical organic radical having from 2 to 20 carbon atoms, R2, R4 and R5 are each an H atom,
X is an anion and
n is 1, 2 or 3,
and
cellulose beads or lignocellulose beads are produced from the solution obtained.

The production of cellulose beads, also referred to as spherical cellulose particles, is known, e.g. from U.S. Pat. No. 4,055,510. U.S. Pat. No. 4,055,510 describes a process in which beads (spherical cellulose particles) are obtained from aqueous solutions of cellulose by coagulation.

WO 03/029329 describes the use of ionic liquids as solvents for cellulose. Fibers or films, for example, can be obtained from the solutions.

The production of cellulose beads from solutions of cellulose in ionic liquids is described in PCT/EP2008/065904. They are produced by the method of underwater pelletization in which the cellulose solution is brought into contact with a second solvent, in particular water, which is miscible with the ionic liquid but in which the cellulose does not dissolve. In contact with the second solvent, the coagulation of the cellulose commences. The desired cellulose beads are obtained in the coagulation by means of suitable geometric devices and suitable measures.

The strengthening of cellulose beads by means of a binder is known from PCT/EP2008/061892.

US 2009/0044942 A1 discloses the use of spherical, porous or nonporous cellulose particles as proppant in petroleum recovery. The cellulose particles can be produced from cellulose-comprising solutions in ionic solvents.

When such cellulose beads are used as filler or support material, as sliding aid or as proppant, beads having very good mechanical properties, in particular a high strength, are desired. Furthermore, the beads should have a low water absorption and a very high heat resistance. The cellulose beads should be able to be produced by means of a very simple process.

It was therefore an object of the present invention to provide such cellulose or lignocellulose beads and a process for producing them.

We have accordingly found the process defined at the outset and cellulose or lignocellulose beads which can be obtained by this process.

The process of the invention produces cellulose beads or lignocellulose beads.

For the present purposes, the term cellulose refers to unmodified or chemically modified cellulose in any form which may additionally comprise further noncellulosic constituents; in particular, the cellulose can be pulp. Pulp consists essentially of cellulose and is obtained by digestion of wood or other cellulose-comprising plants, with the major part of the lignin and if appropriate other noncellulosic constituents being separated off. Possible chemically modified celluloses are, for example, cellulose esters, cellulose ethers, cellulose which has been reacted with amino compounds or subsequently crosslinked cellulose. As cellulose esters, particular mention may be made of cellulose acetate and cellulose butyrate; as cellulose ethers, particular mention may be made of carboxymethylcellulose, methylcellulose and hydroxyethylcellulose. Additional mention may be made of cellulose allophanates and cellulose carbamates.

In particular, the molecular weight of the natural cellulose can also be reduced by means of chemical or enzymatic degradation reactions or by addition of bacteria (bacterial degradation). The cellulose can also comprise low molecular weight polysaccharides, known as polyoses or hemicelluloses (degree of polymerization is in general only from 50 to 250); the proportion of such low molecular weight constituents is, however, generally less than 10% by weight, in particular less than 5% by weight or less than 3% by weight, based on the cellulose. The cellulose can also comprise small amounts of lignin; lignin may, for example, be comprised in amounts of less than 5% by weight or less than 1% by weight. The cellulose can also comprise other noncellulosic constituents. The cellulose preferably comprises at least 80% by weight, particularly preferably at least 90% by weight and in particular at least 95% by weight, of modified or unmodified cellulose as per the chemical definition.

For the purposes of the present invention, the term lignocellulose refers to unmodified or modified cellulose as described above which is present in admixture with lignin or else can be chemically bound to lignin, with the lignocellulose comprising at least 5% by weight of lignin. In particular, the content of lignin in the lignocellulose is from 5 to 60% by weight, preferably from 5 to 40% by weight.

For the purposes of the present invention, cellulose is preferred.

The term beads refers to small particles; these are not particles in the form of fibers but rather spherical particles (spherical cellulose particles, see above). Such particles can be adequately described by indication of a single average diameter.

### Compound of the Formula I

In the process of the invention, cellulose or lignocellulose is firstly dissolved in a solvent which comprises more than 50% by weight of the symmetrical imidazolium compound of the formula I below

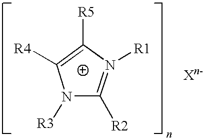

where
R1 and R3 are each an identical organic radical having from 2 to 20 carbon atoms, R2, R4 and R5 are each an H atom,
X is an anion and
n is 1, 2 or 3.
The compound of the formula I is an ionic liquid, i.e. this compound which comprises the symmetrical imidazolium cation and the anion X has a melting point of less than 100° C., preferably less than 80° C., at atmospheric pressure (1 bar).
R1 and R3 in formula I are preferably each a C2-C12-alkyl group, particularly preferably a C2-C4-alkyl group. Very particular preference is given to R1 and R3 each being an ethyl group. The cation in formula I is accordingly 1-ethyl-3-ethylimidazolium (EEIM for short).
n is preferably 1.

As anions, it is in principle possible to use all anions which in combination with the imidazolium cation lead to an ionic liquid.

Customary n-valent anions are possible as anion X. Preference is given to anions having one negative charge, viz. n=1.

The anion [Y]ⁿ⁻ of the ionic liquid is, for example, selected from:

the group of halides and halogen-comprising compounds, in particular:

### F⁻, Cl⁻, Br⁻ and I⁻;

the group of phosphates of the general formulae:
PO₄³⁻, HPO₄²⁻, H₂PO₄⁻, R^{a}PO₄²⁻, HR^{a}PO₄⁻, R^{a}R^{b}PO₄⁻;
the group of phosphonates and phosphinates of the general formulae:

### R^{a}H PO₃⁻, R^{a}R^{b}PO₂⁻, R^{a}R^{b}PO₃⁻;

the group of phosphites of the general formulae:
PO₃³⁻, HPO₃²⁻, H₂PO₃⁻, R^{a}PO₃²⁻, R^{a}HPO₃⁻, R^{a}R^{b}PO₃⁻;
the group of phosphonites and phosphinites of the general formulae:
R^{a}R^{b}PO₂⁻, R^{a}HPO₂⁻, R^{a}R^{b}PO⁻, R^{a}HPO⁻ and
the group of carboxylates of the general formula:

### R^{a}COO⁻.

In the abovementioned anions, R^{a}, R^{b}, R^{c} and R^{d} are each, independently of one another,

hydrogen or an organic radical having a maximum of 20 carbon atoms, where the organic radical may also comprise heteroatoms such as oxygen, nitrogen, sulfur or halogens. Preference is given to R^{a}, R^{b}, R^{c} and R^{d} each being, independently of one another, hydrogen or a hydrocarbon radical without heteroatoms. In particular, R^{a}, R^{b}, R^{c} and R^{d} are each, independently of one another, hydrogen or a hydrocarbon radical having from 1 to 12 carbon atoms.

X— is very particularly preferably an anion having a carboxylate group, in particular an anion as described above from the group of carboxylates of the general formula R^{a}COO—, where R^{a} is as defined above; in the case of the carboxylates, R^{a} is particularly preferably a C1-C10-alkyl group, in particular a C1-C5-alkyl group. R^{a} is very particularly preferably a methyl group and the anion is accordingly an acetate.

In a particularly preferred embodiment, the compound of the formula I is 1-ethyl-3-ethylimidazolium acetate (EEIM acetate for short).

### Dissolution of the Cellulose or Lignocellulose

The solvent used comprises more than 50% by weight of the symmetrical imidazolium compound of the formula I, with mixtures of various compounds of the formula I also being possible. The solvent used particularly preferably comprises more than 80% by weight, in particular more than 85% by weight and very particularly preferably more than 90% by weight or more than 95% by weight, of the compound of the formula I.

The solution may have a residual content of water, e.g. less than 20% by weight, in particular less than 15% by weight, particularly preferably less than 10% by weight and in a particular embodiment less than 5% by weight, of water, based on the solution.

The solution can be prepared by customary methods by addition of the solvent to cellulose or lignocellulose, as described, for example, in WO 03/029329. The dissolution of the cellulose or lignocellulose is preferably carried out at temperatures up to 200° C., particularly preferably at from 60 to 150° C. The dissolution process can be carried out under atmospheric pressure, elevated pressure or preferably reduced pressure, e.g. at pressures of less than 200 mbar.

The cellulose can be dissolved directly in the abovementioned solvent. As an alternative, the solution can be prepared using a solvent mixture which, due to its content of water or other low-molecular weight, volatile compounds, initially does not dissolve the cellulose. The water or the other low-molecular weight, volatile compound is distilled off during the dissolution process, so that the cellulose finally dissolves. Such a process can improve the homogeneity of the solution obtained.

The dissolution process can be aided by mechanical mixing, e.g. by stirring or, in particular, by shearing of the solution. On an industrial scale, kneaders or extruders are particularly suitable for producing such solutions.

In general, the mixture of cellulose or lignocellulose and solvent is stirred at the selected temperature until a homogeneous solution is obtained.

The solution preferably comprises from 1 to 50% by weight, particularly preferably from 2 to 30% by weight and particularly preferably from 5 to 25% by weight, of cellulose or lignocellulose, based on the total weight of the solution. The amounts of starting materials for the dissolution process are selected accordingly.

### Production of the Beads

Beads can be produced from the solution obtained.

For this purpose, the cellulose or lignocellulose has to be precipitated from the solution.

This can preferably be effected by addition of a second solvent or contacting of the solution with a second solvent. The second solvent is a solvent which is miscible with the ionic liquid of the formula I or the solution comprising this but is a precipitant for the dissolved cellulose or lignocellulose.

The second solvent can be a solvent mixture of a plurality of solvents; the solvent mixture then comprises water and other polar, protic solvents such as alcohols or ethers in such amounts that cellulose no longer dissolves in this second solvent and precipitates. The solvent mixture can comprise ionic liquids, in particular ionic liquids as defined above. It is critical that the solvent mixture is a precipitant for the cellulose.

As preferred second solvent, mention may be made of, in particular, water, lower alcohols such as methanol, ethanol, mixtures of water and lower alcohols and mixtures of the above solvents with ionic liquids.

The coagulation of the cellulose or lignocellulose commences on contact with the second solvent.

Shape and size of the cellulose or lignocellulose particles formed are determined or influenced by the specific way in which the process is carried out.

A method of producing beads which is particularly suitable for the purposes of the present invention is the method of underwater pelletization; this method has been described for cellulose solutions in ionic liquids in PCT/EP2008/065904.

In this method, the solution is pushed by means of a suitable conveying means, (e.g. pump or extruder) through a die plate, preferably without contact with air, into the second solvent. The solution is preferably at an elevated temperature, e.g. from 50 to 150° C., in order to reduce the viscosity and to aid carrying out of the method. A knife passes across the holes of the die plate at particular short intervals of time and divides the solution exiting there into small portions. These separated particles acquire a more or less spherical shape owing to the surface tension conditions in the second solvent and are dispersed in the second solvent. As time passes, the solvent of the original solution (ionic liquid) which is still present in the droplets diffuses out of the droplet into the second solvent and at the same time the second solvent diffuses into the bead and leads to coagulation in the interior of the bead, too. The droplet thus hardens within a short time (some seconds to a few minutes); it retains its shape and dimensionally stable beads are formed.

The beads can be separated off, washed if appropriate and dried.

Residual ionic liquid should be removed by washing.

Beads of uniform size are generally obtained after drying. The beads can, depending on the way in which the method is carried out, be obtained in the desired size.

The beads can, for example, have an average diameter of from 100 μm to 10 mm, in particular from 0.1 mm to 5 mm or from 0.2 mm to 2 mm. The average is defined by 50% by weight of the beads having a larger diameter and 50% by weight of the beads having a smaller diameter. The average diameter can be determined by sieve analysis.

Furthermore, the beads preferably have a roundness in accordance with API RP 60 of greater than 0.5; they preferably have a roundness of greater than 0.7; they particularly preferably have a roundness of greater than 0.9.

### Strengthening of the Beads

The beads obtained after precipitation are preferably subsequently strengthened by means of a binder. Suitable binders are described in PCT/EP2008/061892.

Binders which are solvent-free (100% systems) or binders which are dispersible in water or preferably soluble in water are particularly suitable. The binders should preferably be crosslinkable.

Possible binders are, for example, aqueous formaldehyde resins.

Mention may be made of, for example, amino formaldehyde resins such as melamine-formaldehyde resins or urea-formaldehyde resins.

As melamine-formaldehyde resin, mention may here be made by way of example of hexamethoxymethylolmelamine.

Aqueous binders comprising a water-soluble polymer having carboxyl groups or carboxylic anhydride groups and a crosslinker or crosslinkable groups are particularly suitable.

The crosslinker is preferably a compound having hydroxy groups or amino groups, or the crosslinkable groups are preferably hydroxy groups or amino groups.

The binders can comprise acid or acid anhydride groups and the crosslinkable groups in the same polymer (one-component binder); they can also comprise a polymer having acid or acid anhydride groups and a separate crosslinker (two-component binder).

Particular preference is given to two-component binders comprising a polymer having acid or acid anhydride groups and a crosslinker having hydroxyl groups or amino groups, particularly preferably hydroxyl groups.

Suitable polymers having an acid or acid anhydride group can be obtained, in particular, by free-radical polymerization of ethylenically unsaturated compounds (monomers).

Preferred polymers comprise from 5 to 100% by weight, particularly preferably from 10 to 100% by weight and very particularly preferably from 30 to 100% by weight, of monomers having at least one acid or acid anhydride group. This is preferably a carboxyl group or carboxylic anhydride group.

Monomers having a carboxyl group are, for example, C3-C10-monocarboxylic acids such as acrylic acid, methacrylic acid, ethylacrylic acid, allyl acetic acid, crotonic acid, vinyl acetic acid or a monoester of maleic acid.

Particularly preferred polymers comprise from 5 to 100% by weight, preferably from 5 to 50% by weight and particularly preferably from 10 to 40% by weight, of an ethylenically unsaturated carboxylic anhydride or an ethylenically unsaturated dicarboxylic acid whose carboxyl groups can form an anhydride group.

Such carboxylic anhydrides or dicarboxylic acids are, in particular, maleic acid, maleic anhydride, itaconic acid, norbornenedicarboxylic acid, 1,2,3,6-tetrahydrophthalic acid, 1,2,3,6-tetrahydrophthalic anhydride.

Particular preference is given to maleic acid and maleic anhydride.

Apart from the abovementioned monomers, the polymer can comprise any further monomers. The monomers are preferably selected so that the polymer is soluble in water (21° C., 1 bar). In the case of the particularly preferred polymers having the abovementioned content of an ethylenically unsaturated carboxylic anhydride or an ethylenically unsaturated dicarboxylic acid, the polymer can, in particular, further comprise monomers having a carboxyl group. Suitable polymers are, for example, copolymers of maleic acid or maleic anhydride with acrylic acid or methacrylic acid.

Suitable crosslinkers are compounds having hydroxyl groups or amino groups, in particular at least two hydroxyl groups or amino groups in the molecule.

Particular preference is given to crosslinkers having hydroxyl groups. The crosslinker preferably comprises at least two hydroxy groups in the molecule.

This can be, for example, a low-molecular weight alcohol such as glycol or glycerol. Particular preference is given to an alkanolamine having at least 2 hydroxyl groups.

Preference is given to alkanolamines of the formula (II)

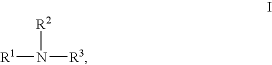

where R1 is an H atom, a C1-C10-alkyl group or a C2-C10-hydroxyalkyl group and R2 and R3 are each a C2-C10-hydroxyalkyl group.

Particular preference is given to R2 and R3 each being, independently of one another, a C2-C5-hydroxyalkyl group and R1 being an H atom, a C1-C5-alkyl group or a C2-C5-hydroxyalkyl group.

As compounds of the formula (II), particular mention may be made of diethanolamine, triethanolamine, diisopropanolamine, triisopropanolamine, methyldiethanolamine, butyldiethanolamine and methyldiisopropanolamine. Particular preference is given to triethanolamine.

The polymer and the crosslinker, e.g. the alkanolamine, are preferably used in a ratio to one another so that the molar ratio of carboxyl groups of the polymer to the hydroxyl groups or amino groups of the crosslinker is from 20:1 to 1:1, preferably from 8:1 to 5:1 and particularly preferably from 5:1 to 1.7:1 (anhydride groups are here counted as 2 carboxyl groups).

Suitable binders can be obtained from BASF under the trade name Acrodur®.

The two-component binder is produced, for example, in a simple fashion by addition of the crosslinker to the solution of the polymer.

To strengthen the beads, the beads can, preferably after washing and drying as above, be brought into contact with the binder. The beads are preferably introduced into the aqueous dispersion or preferably aqueous solution of the binder. The beads take up binder and swell. The swollen beads can be separated off. If appropriate, separate drying to remove the solvent and crosslinking of the binder under suitable conditions can subsequently be carried out.

Drying can, for example, be carried out at temperatures of from 20 to 100° C., and crosslinking can likewise be carried out at least partly at these temperatures; the temperature for crosslinking is preferably increased to above 100° C., e.g. from 100 to 200° C. Complete crosslinking has generally occurred after from 2 to 30 minutes at this elevated temperature.

The strengthened beads obtained preferably have a binder content of at least 5% by weight, particularly preferably at least 10% by weight, very particularly preferably at least 20% by weight, based on the total weight of the dry beads. In general, the proportion of binder is not more than 80% by weight, in particular not more than 60% by weight. All weights reported are based on the weight of the dry, strengthened beads. The beads can additionally comprise further constituents, e.g. additives such as stabilizers, biocides, etc.

The beads which can be obtained by the process of the invention have a high strength, a high heat resistance and a low water absorption.

They are therefore suitable for all customary applications of such beads, in particular as filler, support material or sliding aid.

They are suitable as filler in, for example, hydraulically setting systems such as gypsum plaster or mortar; for example, plasters or renders having an aesthetic surface structure can be obtained in this way.

They are suitable as filler in paper or board and can here reinforce the material; for this purpose, they can be added to the starting materials in production of paper and board.

They are generally suitable as packaging material or for other uses in which protection against mechanical damage (shock protection, impact protection) is of importance.

They are suitable as spacers in sandwich structures or for pressure-resistant filling of hollow spaces.

They can be support material for functional compounds of a variety of types and can be used, in appropriately modified form, as, for example, column material in chromatography, as supported catalyst in heterogeneous catalysis or as pigment.

They can likewise be support material for active compounds, with a slow-release action also being able to be achieved. The slow-release action is due to a delay in liberation of active compounds from the interior of the beads caused by diffusion.

The beads can additionally be used as sliding aid for the transport of heavy loads.

In a particularly preferred embodiment of the invention, the beads which can be obtained by the process of the invention can be used for petroleum and natural gas recovery, in particular in petroleum recovery. Particles for such applications are frequently referred to as “proppants”. They can for this purpose be used as component of various formulations, in particular aqueous formulations for the treatment of wells and/or underground petroleum or natural gas formations. They can be used, for example, as components of “fracturing fluids” or “sand control fluids”. Fracturing fluids comprise, inter alia, thickening constituents such as thickening polymers and/or surfactants, proppants and, if appropriate, further components.

Fracturing fluids can be injected under high pressure into a production well and penetrate into the formation. The applied pressure results in formation of new fractures or channels in the formation. The proppants penetrate together with the fluid into the channels and prevent the channels from closing after the pressure treatment has ended. The channels which have been formed and kept open by the proppants allow petroleum or natural gas to flow more readily again from the formation into the production well after fracturing.

Further details regarding the use of proppants are described, for example, in US 2009/0044942.

### EXAMPLES

All process steps were carried out in the same way both using the solvent 1-ethyl-3-methylimidazolium acetate (EMIM acetate, for comparison) and with 1-ethyl-3-ethylimidazolium acetate (EEIM acetate, according to the invention). Both are referred to as “ionic liquid” in the interest of simplicity in the following description.

### 1.) Mixing and Dissolution of the Cellulose:

35.0 g of Sappi Sailyo pulp (degree of polymerization (DP)=830 (determined by the Cuen method, DIN 54270, part 2)) are placed in a 4 I glass reactor provided with an anchor stirrer and 315.0 g of ionic liquid are poured over the pulp. The reactor is flushed with nitrogen and at the same time heated to an internal temperature of 110° C. After the internal temperature has been reached, reduced pressure is applied (water pump vacuum, max. 50 mbar) and the mixture is stirred for 5 h at constant temperature. The homogeneous solution is packaged in appropriate transport containers and cooled in these.

### 2.) Underwater Pelletization:

The experimental setup corresponded to the experimental setup described in PCT/EP2008/065904. The experiment was also carried out analogously. In contrast to the method described in PCT/EP2008/065904, the precipitated cellulose beads were not separated off by means of a sieve but by means of a centrifuge.

The 10% strength cellulose solution in ionic liquid was supplied in sheet metal buckets. The solution was heated to 100° C. in an oven before processing. The solution was transferred into the jacket-heated reservoir of a gear pump which had been heated by means of a heating coil which was additionally located in the product space. Via a gear pump which had been heated to 100° C. and was connected by means of a swagelock metal hose which had been heated to 100° C. to the die plate heated to 100° C. of an underwater pelletization apparatus (LPU, from GALA). 8×0.8 mm holes ran through the die plate.

The cellulose solution was pushed through the holes in the die plate by means of the gear pump (throughput: 7.5 kg/h) and parted by means of a fast-rotating knife (5 cutters, pitch 22.5°, 2000 rpm) and carried away by the liquid of the precipitation bath flowing past the rotating knives, with at the same time solvent exchange taking place between the cellulose particles and the bath liquid, water diffusing into the beads and ionic liquid diffusing from the beads into the bath liquid and the beads hardening with increasing water content. The content of ionic liquid in the bath was limited to about 12% by weight by regular replacement by fresh water. Large deviations from this region lead to malfunctions, for example foaming.

The throughput was 0.94 kg/hole×h, the mass pressure was 2-3 bar. The temperature in the circuit was about 22° C. and the circulation rate in the circuit was 1200 kg/h, with the length of the process water line from the knife box to the centrifuge being 7700 mm.

The EEIM acetate solution had a lower viscosity than EMIM acetate solutions and was readily processible even at 100° C., while EMIM acetate was still difficult to handle even at 120° C.

3.) Washing of the Cellulose Beads after Underwater Pelletization:

The first wash was carried out in a 20 I container provided with a drum stirrer. The moist beads were subsequently introduced into a 700 I stirred vessel for the subsequent washes.

The first wash was carried out at a washing water ratio (WR, i.e. mass ratio of washing water to mass of moist beads) of 1; the beads were stirred in the appropriate volume of water for 20 minutes and subsequently filtered off under atmospheric pressure by means of a filter bag. This wash was followed by 5 further washes carried out in the same way, but at an increased WR of 20. Between these washes, the stirrer was switched off and the supernatant liquid was drawn off after sedimentation of the beads.

After the 6th wash, the beads are filtered off under atmospheric pressure via a filter bag.

### 4.) Strengthening

The undried cellulose beads are stirred in a 20% aqueous Acrodur 950 L® solution at 25° C. for 30 minutes. Acrodur 950 L is a polycarboxylic acid combined with a crosslinker comprising hydroxyl groups. After the swelling step, the cellulose beads are filtered off under atmospheric pressure.

### 5.) Drying and Crosslinking:

The cellulose beads impregnated with aqueous Acrodur are dried in a fluidized-bed drier using drying gas at about 70° C. until moisture was no longer measured in the exhaust air.

For crosslinking, the temperature in the fluidized-bed drier is slowly increased to 185-205° C. and maintained for about 30-90 minutes until all particles are uniformly crosslinked.

### 6.) Characterization of the Beads:

Two modified cellulose beads produced as described in 1.)-5.) are compared, with the beads A being produced from EMIM acetate solution and the beads B being produced from EEIM acetate solution.

Both the water retention value in accordance with ISO 23714 and the mechanical deformation were determined.

### Water Retention Value

The water retention value of sample A and sample B at various points in time is significantly different (table 1, FIG. 1). The water retention value is the weight ratio of the amount of water retained in the beads in accordance with ISO 23714 to the weight of the dry beads. The smaller the value, the lower the water absorption.

TABLE 1
Water retention value (WRV)

| Time | WRV of sample A | WRV of sample B |
|---|---|---|
| [h] | [%] | [%] |
| 2 | 2.1 | 1.5 |
| 24 | 3.1 | 1.5 |
| 48 | 7.4 | 1.5 |
| 96 | 11.8 | 2.2 |

### Mechanical Deformation

To determine the deformation of the modified cellulose beads A and B, 5 beads were in each case loaded with an applied force of 40 N/individual bead in pure deionized water at room temperature and the average deformation was determined from the 5 individual measurements (table 2). The deformation of the beads was determined in scale divisions.

TABLE 2
Average deformation

| Time | Deformation of sample A | Deformation of sample B |
|---|---|---|
| [h] | [scale divisions] | [scale divisions] |
| 0.25 | 2.6 | 2.6 |
| 0.5 | 4 | 4 |
| 0.75 | 4 | 4 |
| 1 | 4.2 | 4.2 |
| 24 | 14 | 6.8 |
| 48 | 33.4 | 7.8 |
| 72 | 39.6 | 8.2 |
| 96 | 42.6 | 8.2 |

1-16. (canceled)

17. A process for producing cellulose beads or lignocellulose beads, wherein cellulose or lignocellulose is dissolved in a solvent which comprises more than 50% by weight of the symmetrical imidazolium compound of the formula I below 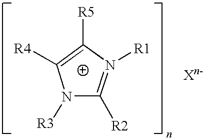
where
R1 and R3 are each an identical organic radical having from 2 to 20 carbon atoms,
R2, R4 and R5 are each an H atom,
X is an anion and
n is 1, 2 or 3,
and
cellulose beads or lignocellulose beads are produced from the solution obtained.

18. The process according to claim 17, wherein R1 and R3 in formula I are each a C2-C12-alkyl group and n is 1.

19. The process according to claim 17, wherein R1 and R3 are each an ethyl group.

20. The process according to any of claims 17, wherein the anion is an anion having a carboxylate group.

21. The process according to claim 17, wherein the anion is acetate.

22. The process according to claim 17, wherein the symmetrical imidazolium compound is 1-ethyl-3-ethylimidazolium acetate (EEIM acetate).

23. The process according to claim 17, wherein the solvent comprises more than 80% by weight of the symmetrical imidazolium compound.

24. The process according to claim 17, wherein the solution obtained comprises from 1 to 50% by weight of cellulose or lignocellulose.

25. The process according to claim 17, wherein cellulose or lignocellulose are precipitated from the solution by addition of a second solvent which does not dissolve cellulose or lignocellulose but is miscible with the symmetrical imidazolium compound.

26. The process according to claim 25, wherein the cellulose or lignocellulose is shaped to form beads during or after the precipitation.

27. The process according to claim 25, wherein the precipitation and shaping of the beads is carried out by the method of underwater pelletization.

28. The process according to claim 17, wherein the beads obtained are strengthened by means of a binder.

29. The process according to claim 28, wherein the beads obtained are strengthened by use of an aqueous binder which comprises a water-soluble polymer having carboxyl groups or carboxylic anhydride groups and a crosslinker.

30. A cellulose bead or lignocellulose bead which can be obtained by a process according to claim 17.

31. A method of using cellulose beads or lignocellulose beads according to claim 30 for petroleum and/or natural gas recovery by introducing the particles into an underground petroleum or natural gas formation.

32. A method of using the cellulose beads or lignocellulose beads according to claim 30 for fracturing underground petroleum or natural gas formations by introducing an aqueous formation comprising at least one proppant according to claim 30 and thickening components under pressure into an underground petroleum or natural gas formation.
